(19) United States
(12) Patent Application Publication
(10) Pub. No.: US 2007/0102123 A1
(43) Pub. Date: May 10, 2007

(54) Elastic blind

(76) Inventor: Jin Young Kim, Bronx, NY (US)

Correspondence Address: JIN YOUNG KIM, 1957 Bronxdale Ave. #C-32, Bronx, NY, 10462, US

(21) Appl. No.: 11/271,243

(22) Filed: Nov. 7, 2005

(51) Int. Cl. E06B 9/08

(52) U.S. Cl. 160/23.1

(57) ABSTRACT

When driving or parking, the Elastic Blind prevents the direct sun rays to penetrate the car windows. Just by stretching the blind to cover desired areas, intense, harmful UV rays are blocked from damaging passenger's skin or eyes, and indoor is retained cool and refreshing in midst of hottest heat waves. Furthermore, during cold weather, the Elastic Blind effectively cuts off cold waves from entering inside and keeps indoor warm. The compact-designed blind container incorporates tape spring or roller spring or motor that it automatically rolls the blind into the container once the tension stretching the blind is removed.

### BACKGROUND OF THE INVENTION

1. Field of the Invention

The Elastic Blind is designed to prevent light, heat and cold from barging into the car. The blind's elasticity guarantees blockade for all car windows, and the range of coverage can be determined by passenger's desire.

2. Description of the Invention

When a car is parked outdoor, all the windows must be shut in order to prevent car theft. However, this seal results in unbearable indoor conditions that lack of air circulation and consistent light penetration escalate indoor temperature. Thus, the Elastic Blind is invented to ease those sufferings of passenger. Just by stretching the Blind in accordance with sun's position and direction of sun rays, passengers can easily avoid the most discomforting car experience.

### OBJECT OF THE INVENTION

When driving, using the Elastic Blind protects passengers' skins and eyes from harmful UV rays and prevents the indoor temperature to escalate to an extreme degree.
When parking under the direct sun light, the Elastic Blind regulates the indoor temperature by blocking off intense sun light. During cold weather, the blind acts as a curtain and absorbs and warms the cold waves that pass through the car windows.
The blind's ability to regulate car's indoor temperature results in reduction of fuel cost.

### SUMMARY OF THE INVENTION

The blind is composed of a mixture of rubber and fibers. Therefore, it is very flexible and durable. Its flexibility allows the invention to cover the entire car windows with only the half the length of non-flexible blind required to cover same area. The container with its automatic reverse mechanism, conveniently and efficiently stores the blind by simultaneously, pulling and rolling the blind within its compartment. Its slim design also allows easy compatibility when installed. The container neither distracts driver while driving nor disturb passengers when getting on and off the car. There are two ways to use the Elastic Blind:1) user can-manually pull the blind, stretch it, and fix it at the opposite side of the container, or 2) use motor inside the container to release the blind automatically. Both spring and motor oriented Blinds incorporate the automatic reverse system that the container automatically pulls and rolls the blind. The spring oriented container rolls the blind once the tension is removed, and the motor oriented container reverses the blind when the automatic reverse switch is turned on.

### BRIEF DESCRIPTION OF THE DRAWINGS

FIG. 1: the blind when stretched

FIG. 2: the stretched blind (represented by the dotted lines) completely rolled into the container

FIG. 3: 1's original length elongated in 1-c direction by the amount of 1-b (refer to FIG. 1)

FIG. 4: the blind stretched for the front side car window

FIG. 4-A: the blind rolled back into the container

FIG. 5: the blind stretched for the back-side car window

FIG. 5-A: the blind rolled back into the container

FIG. 6: the blind stretched for the back window (refer to FIG. 1)

FIG. 6-A: the blind rolled back into the container

FIG. 7: the container (refer to FIG. 8 and FIG. 9)

FIG. 8: cross-sectional view of the container incorporating a tape spring in a resting state

FIG. 8-A: top view of the tape spring in a resting state (refer to FIG. 8)

FIG. 8-B: bottom view of the tape or roller spring in a resting state (refer to FIG. 8)

FIG. 9: cross-sectional view of the container incorporating a tape spring when the blind is stressed

FIG. 9-A: top view of the tape spring when the blind is stressed (refer to FIG. 9)

FIG. 9-B: bottom view of the tape spring when the blind is stressed (refer to FIG. 9)

FIG. 10: cross-sectional view of the container incorporating a roller spring in a resting state (refer to FIG. 8-A)

FIG. 10-A: cross-sectional view of the container incorporating a roller spring when the blind is stressed (refer to FIG. 9-A)

FIG. 11: container incorporating a motor

FIG. 11-A: motor releasing or pulling the blind by spinning on the axis of rotation

### REFERENCE NUMBER

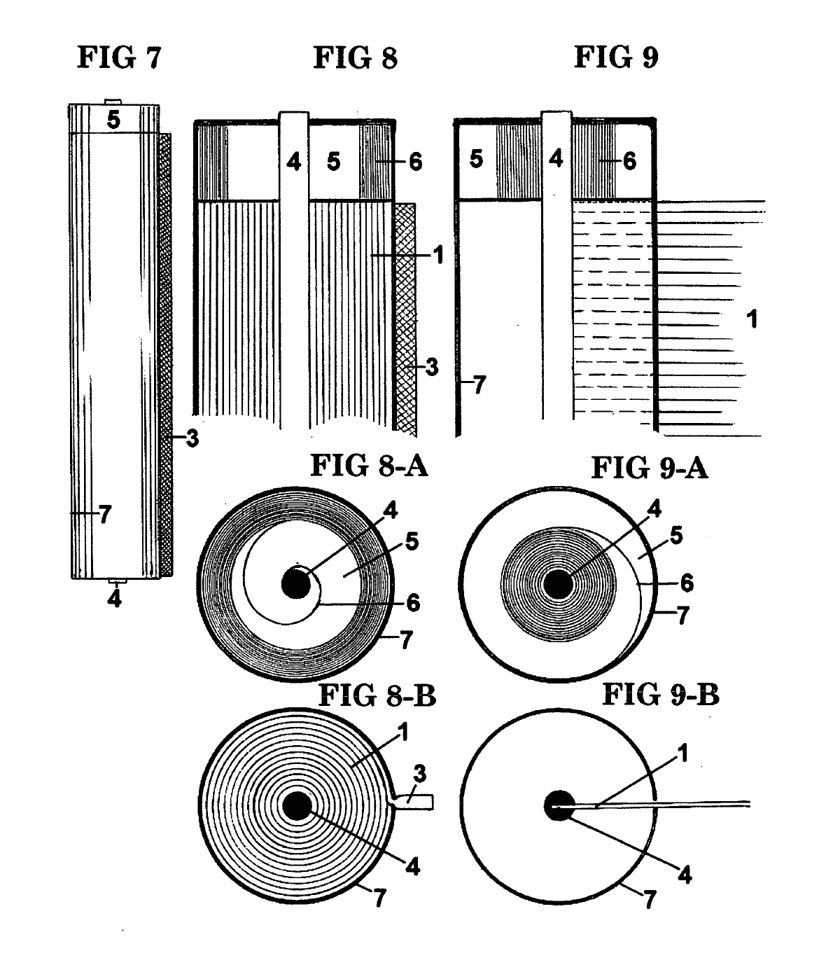

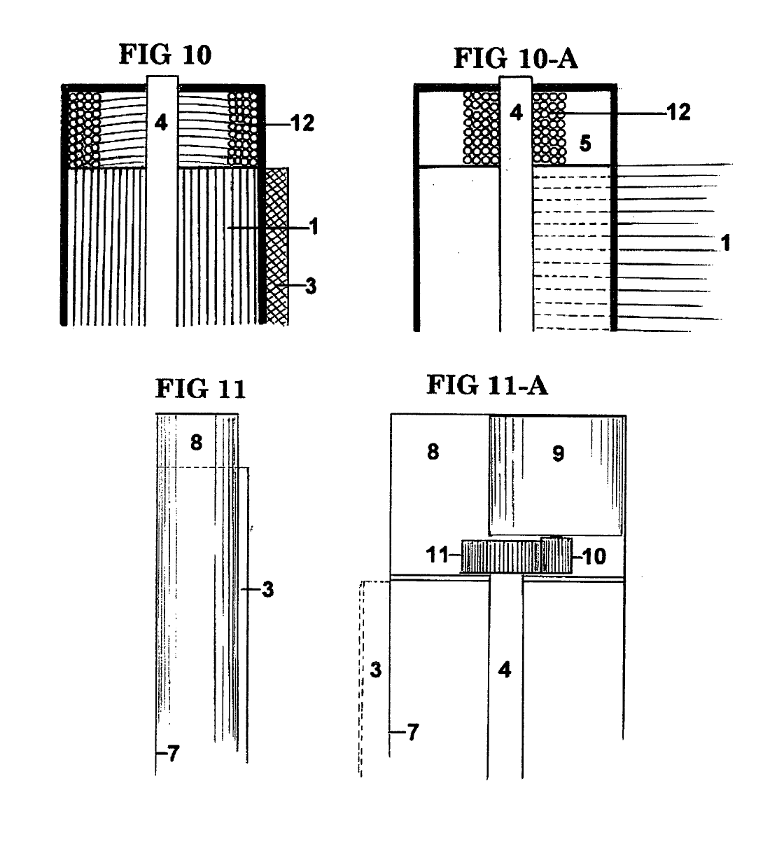

1: the stretchable blind
1-a: shape of the stretched blind (represented by dotted lines)
1-b: expanded area of the blind
1-c: direction
2: scaled down image of the container in FIG. 7
3: handle or any mechanism that fixates the blind at the opposite side of the container
4: an axis of rotation for the blind
5: compartment for a tape spring or a roller spring
6: tape spring
7: the container
8: motor compartment in the container
9: motor
10: rotational gear of the motor
11: rotational gear of the blind
12: roller spring

### DESCRIPTION OF THE PREFERRED EMBODIMENT

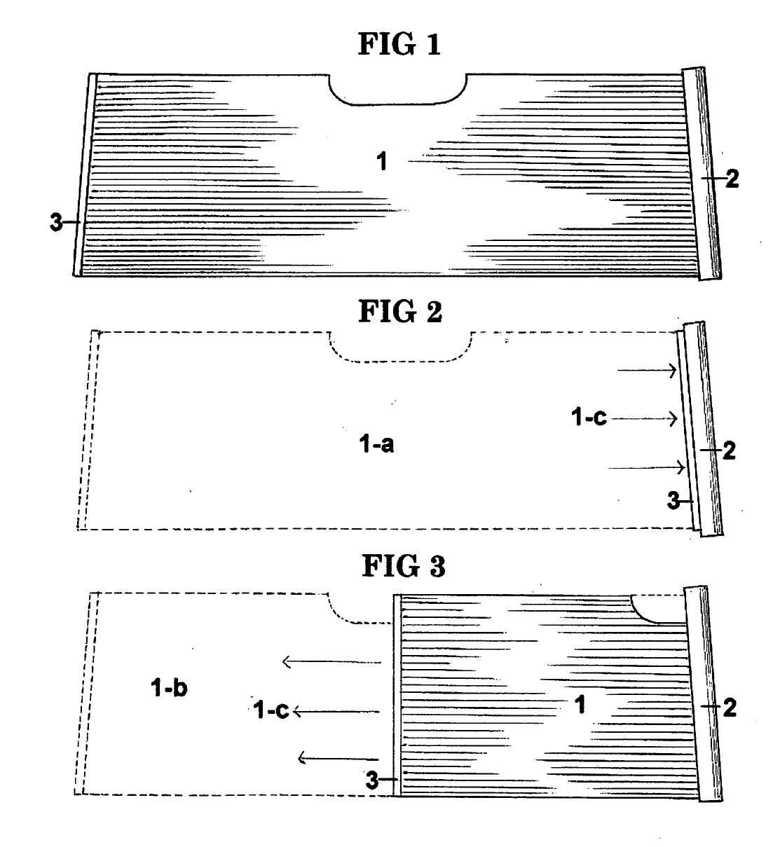

The stretchable blind, specifically designed for car's indoor cuts off light, heat and cold.
Front window-upon installing 2 of FIG. 1 at one side of car frame next to the front window, pulling 3 to the direction of 1-c in FIG. 3 results in expanded area of the blind as shown in 1-a, FIG. 2. When 3 is fixated at the opposite side of the container, the blind is stretched as shown FIG. 1.

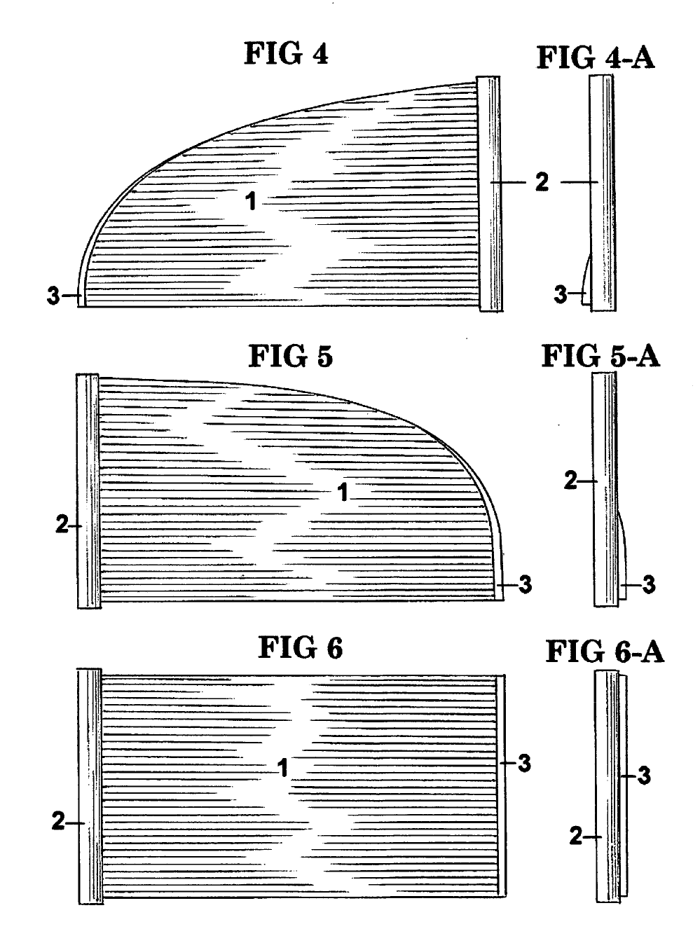

Front side window—upon installing 2 of FIG. 4 at the frame between the front and back side windows, pulling and fixating 3 at the opposite front end of the window results in FIG. 4.

Back side window—upon installing 2 of FIG. 5 at the middle frame between the front and back side windows, pulling 3 and then, attaching it at the other end of the window results in FIG. 5

Back window—upon installing 2 of FIG. 6 at the frame next to the back window, pulling 3 and then, fixating at the opposite side of the container results in FIG. 1.

When storing the blind, detaching and releasing 3 from the locking mechanism cause 6 of FIG. 9, which is attached to 4, to roll back the blind automatically by spring's elasticity. The removal of the force pulling 3 loosens 6 of FIG. 8-A, and simultaneously causes 4 to spin on its axis, rolling the blind into the container (as shown in FIG. 8-A and FIG. 8-B).

When the motor is turned on, the motor spins 10 in FIG. 11-A, and causes 11 in FIG. 11-A to spin simultaneously. 11 then, rotates 4 to either release or pull the blind attached to 4 automatically (as shown in FIG. 11-A)

1. Elastic blind whose original length, 1 in FIG. 3, elongates by the amount of 1-b when 3 is pulled to the direction of 1-c.

2. The cylinder-shaped container rolling and releasing the blind

3. Tape spring mechanism which releases the blind when the blind is manually pulled, and which automatically reverses the blind once the tension is removed (refer to FIG. 8-A and FIG. 9-A)

4. Automatic releasing and reversing of the blind with motor mechanism (refer to FIG. 11 and FIG. 11-A)

5. Roller spring mechanism which releases the blind when the blind is manually pulled, and which automatically reverses the blind once the tension is removed
